(19) United States
(12) Patent Application Publication
(10) Pub. No.: US 2025/0192352 A1
(43) Pub. Date: Jun. 12, 2025

(54) BATTERY PACK VENTING SYSTEM AND VENTING METHOD

(71) Applicant: Ford Global Technologies, LLC, Dearborn, MI (US)

(72) Inventors: Antony George Schepak, Howell, MI (US); Patrick Daniel Maguire, Ann Arbor, MI (US); Mohammadreza Eftekhari, Novi, MI (US); Daniel Benjamin Kok, Ann Arbor, MI (US); George Albert Garfinkel, Westland, MI (US)

(21) Appl. No.: 18/634,695

(22) Filed: Apr. 12, 2024

Related U.S. Application Data
(60) Provisional application No. 63/607,888, filed on Dec. 8, 2023.

(51) Int. Cl. H01M 50/358; H01M 50/211; H01M 50/342

(52) U.S. Cl. CPC H01M 50/358; H01M 50/211; H01M 50/3425

(57) ABSTRACT

A battery pack venting system, including: a structural member having a first channel and a second channel, the first channel configured to communicate a flow of vent byproducts received through at least one first inlet in a first direction to a first outlet from the structural member, the second channel configured to communicate a flow of vent byproducts received through at least one second inlet in a second direction to second outlet from the structural member.

### CROSS-REFERENCE TO RELATED APPLICATIONS

This disclosure claims the benefit of U.S. Provisional Application No. 63/607,888, which was filed on Dec. 8, 2023, and is incorporated herein by reference in its entirety.

### TECHNICAL FIELD

This disclosure relates generally to traction battery packs and, more particularly, to communicating vent byproducts from battery cells to an area outside the battery pack.

### BACKGROUND

Electrified vehicles include a traction battery pack for powering electric machines and other electrical loads of the vehicle. The traction battery pack can include a plurality of battery cells and various other battery internal components that support electric vehicle propulsion.

### SUMMARY

In some aspects, the techniques described herein relate to a battery pack venting system, including: a structural member having a first channel and a second channel, the first channel configured to communicate a flow of vent byproducts received through at least one first inlet in a first direction to a first outlet from the structural member, the second channel configured to communicate a flow of vent byproducts received through at least one second inlet in a second direction to second outlet from the structural member.

In some aspects, the techniques described herein relate to a battery pack venting system, wherein the structural member extends along a structural member axis, wherein the at least one first inlet is axially closer to the second outlet than the first outlet, wherein the at least one second inlet is axially closer to the first outlet than the second outlet.

In some aspects, the techniques described herein relate to a battery pack venting system, wherein the at least one first inlet and the at least one second inlet are each configured to receive a flow of vent byproducts from an area between a pair of cross-member assemblies.

In some aspects, the techniques described herein relate to a battery pack venting system, wherein the structural member is an extruded structural member.

In some aspects, the techniques described herein relate to a battery pack venting system, wherein the structural member spans a plurality of cell stacks.

In some aspects, the techniques described herein relate to a battery pack venting system, including: a structural member having a first channel and a second channel, the first channel configured to communicate a flow of vent byproducts received through at least one inlet in a first direction, the second channel configured to communicate at least some of the flow of vent byproducts in an opposite, second direction.

In some aspects, the techniques described herein relate to a battery pack venting system, wherein the structural member spans a plurality of cell stacks.

In some aspects, the techniques described herein relate to a battery pack venting system, further including a redirecting member that receives the flow of vent byproducts from the first channel and redirects the flow of vent byproducts into the second channel.

In some aspects, the techniques described herein relate to a battery pack venting system, wherein the second channel is configured to communicate at least some of the flow of vent byproducts an at least one outlet from the structural member.

In some aspects, the techniques described herein relate to a battery pack venting system, further including a third channel of the structural member, the third channel configured to communicate at least some of the flow of vent byproducts that have passed through the first channel to at least one outlet from the third channel of the structural member, the flow of vent byproducts moving in the second direction through the third channel.

In some aspects, the techniques described herein relate to a battery pack venting system, wherein the first channel is disposed between the second channel and the third channel.

In some aspects, the techniques described herein relate to a battery pack venting system, further including a redirecting member that receives the flow of vent byproducts from the first channel and redirects some of the flow of vent byproducts into the second channel and some of the flow of vent byproducts into the third channel.

In some aspects, the techniques described herein relate to a battery pack venting system, further including a third channel and fourth channel, the second channel configured to communicate at least some of the flow of vent byproducts from the first channel to the third channel and further configured to communicate at least some of the flow of vent byproducts from the first channel to the fourth channel.

In some aspects, the techniques described herein relate to a battery pack venting system, wherein the first channel and the second channel are sandwiched between the third channel and the fourth channel.

In some aspects, the techniques described herein relate to a battery pack venting method, including: communicating a flow of vent byproducts in a first direction through a channel of a structural member within a battery pack; communicating the flow of vent byproducts in a second direction through an area between the structural member and an enclosure wall of the battery pack; and communicating the flow of vent byproducts through a battery pack vent to an area outside the battery pack.

In some aspects, the techniques described herein relate to a battery pack venting method, further communicating the vent byproducts to the structural member from an area between a pair of cross-member assemblies that each extend in a cross-vehicle direction, the structural member arranged transverse to pair of the cross-member assemblies.

In some aspects, the techniques described herein relate to a battery pack venting method, further including turbulating the flow of vent byproducts using at least one turbulator of the structural member, of the enclosure wall, or both.

In some aspects, the techniques described herein relate to a battery pack venting method, wherein the structural member spans a plurality of cell stacks.

In some aspects, the techniques described herein relate to a battery pack venting method, wherein the communicating of the flow of vent byproducts in the second direction is outside of the structural member.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack according to an exemplary embodiment of the present disclosure.

FIG. 2 illustrates a perspective and partially expanded view of selected portions of the battery pack of FIG. 1.

FIG. 3 illustrates a schematic top view of the battery pack of FIG. 2.

FIG. 4 illustrates a side view of a structural member from a passenger side of the battery pack of FIG. 3.

FIG. 5 illustrates a section view taken at line 5-5 in FIG. 4.

FIG. 6 illustrates a partial view of the battery pack along with a side view of a structural member according to another exemplary aspect of the present disclosure.

FIG. 7 illustrates a section view taken at line 7-7 in FIG. 6.

FIG. 8 illustrates a partial view of the battery pack along with a side view of a structural member according to yet another exemplary aspect of the present disclosure.

FIG. 9 illustrates a section view taken at line 9-9 in FIG. 8.

FIG. 10 illustrates a partial view of the battery pack along with a side view of a structural member according to still another exemplary aspect of the present disclosure.

### DETAILED DESCRIPTION

This disclosure details exemplary systems and methods utilized to communicate vent byproducts from battery cells to an area outside the battery pack. The systems and methods involve communicating the vent byproducts in ways that lengthen a time the vent byproducts are contained within the battery pack before the vent byproducts are exhausted from the battery pack. Lengthening a time the vent byproducts spend inside the battery pack can help to reduce thermal energy level within the vent byproducts before they are exhausted from the battery pack. These and other features are discussed in greater detail in the following paragraphs.

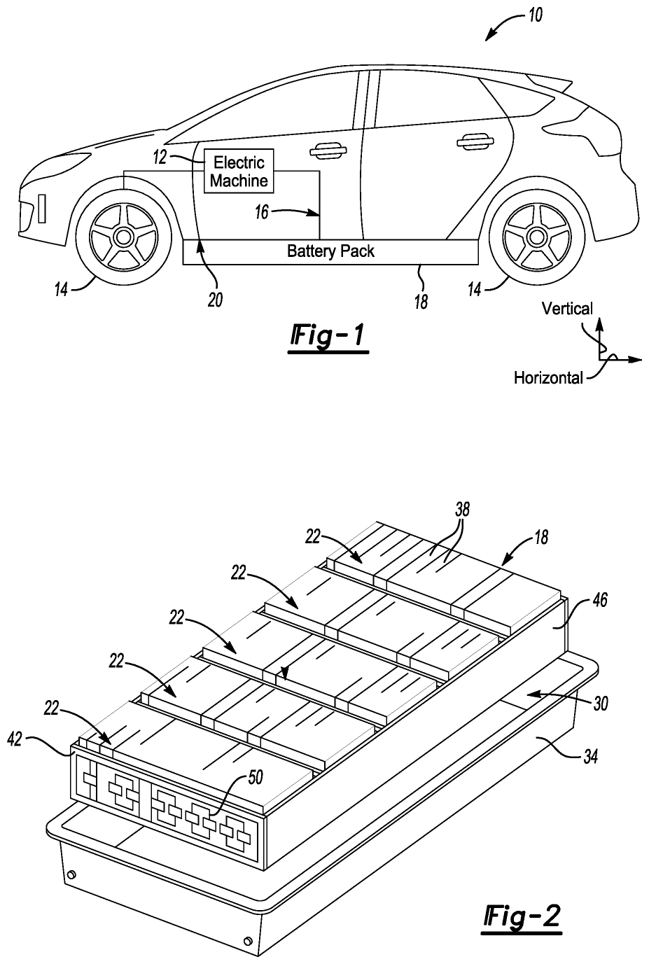

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 electrically couples the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 is secured to an underbody 20 of the electrified vehicle 10. However, the traction battery pack 18 could be located elsewhere on the electrified vehicle 10 in other examples.

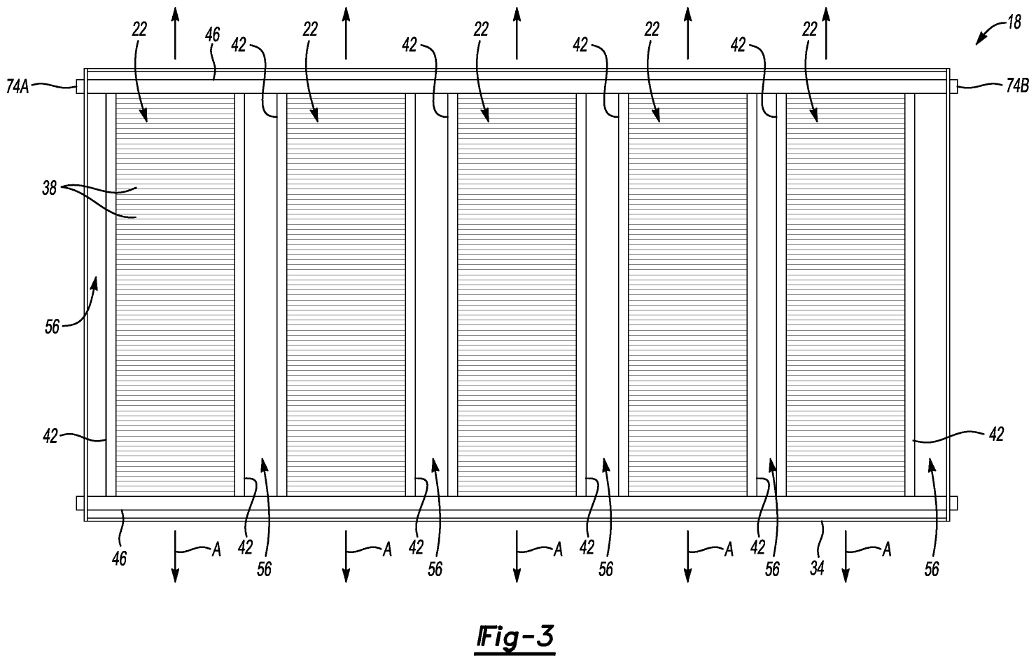

With reference to FIGS. 2-4, the traction battery pack 18 includes a plurality of cell stacks 22 housed within an interior area 30 of an enclosure. Here the cell stacks 22 fit within an enclosure tray 34, which can be secured to an enclosure cover, the underbody 20, or both to enclose the cell stacks 22 and other battery internal components within the interior area 30.

Each cell stack 22 includes a plurality of battery cells 38 stacked side-by-side relative to one another along a respective cell stack axis A. The battery cells 38 store and supply electrical power for powering various components of the electrified vehicle 10.

In the exemplary embodiment, the battery cells 38 are lithium-ion, pouch-style battery cells. However, battery cells having other geometries (cylindrical, prismatic, etc.) and/or chemistries (nickel-metal hydride, lead-acid, etc.) could alternatively be utilized within the scope of this disclosure.

The cell stacks 22 can additionally include dividers, thermal interface materials, adhesives, and other materials between the individual battery cells 38. Although a specific number of the cell stacks 22 are illustrated in the various figures of this disclosure, the traction battery pack 18 could include any number of the cell stacks 22.

The battery cells 38 of the cell stacks 22 are positioned between a pair of cross-member assemblies 42 such that the battery cells 38 are alongside the cross-member assemblies 42. The cross-member assemblies 42 described herein are configured to increase the structural integrity of the traction battery pack 18. Each of the cross-member assemblies 42 can be configured to transfer a load applied to a side of the electrified vehicle 10.

In an embodiment, the cell stacks 22 and the cross-member assemblies 42 extend longitudinally in a cross-vehicle direction of the electrified vehicle 10. However, other configurations are contemplated within the scope of this disclosure.

Among other functions, the cross-member assemblies 42 may be configured to hold the battery cells 38 and at least partially delineate the cell stacks 22 from one another within the interior area 30. The cross-member assemblies 42 can carry busbars in some examples. The exemplary battery cells 38 include tab terminals that project outwardly from a battery cell housing. At least some of the tab terminals can extend through a respective aperture in the cross-member assemblies 42 to electrically connect to each other or to one or more of the busbars.

In this example, a pair of structural members 46 span over ends of the plurality of cell stacks 22. One of the structural members 46 is on a driver side of the cell stacks 22. The other structural member 46 spans the cell stacks 22 on a passenger side of the cell stacks 22. The pair of structural members 46 are oriented along a length of the vehicle 10 and are thus, in this example, arranged transverse to the cross-member assemblies 42. Each of the cross-member assemblies 42 can interface with the structural members 46 to accommodate tension loads resulting from expansion and retraction of the battery cells 38.

In this example, the structural members 46 are extruded structures. A person having skill in this art would be able to structurally distinguish an extruded structure from a structure that is not extruded. The structural members 46 can be extruded aluminum, for example. The structural members 46 can be considered “megabars.”

From time to time, pressure and thermal energy within at least one of the battery cells 38 in the cell stacks 22 can increase. This can lead to the battery cell 38 discharging a flow of vent byproducts, which can include gas and debris. The vent byproducts can be discharged from the battery cell 38 through a designated cell vent within a housing of the battery cell 38. The cell vent can be a membrane that yields in response to increased pressure and thermal energy within the battery cell 38. The cell vent can also be a ruptured area of the associated battery cell 38.

In the exemplary embodiment, the cell stacks 22 and their battery cells 38 are configured to vent through one or more apertures 50 in the cross-member assemblies 42 into an open area 56 that is next to at least one of cross-member assemblies 42. From there, the vent byproducts flow laterally outward toward the structural members 46.

The structural members 46 receive the vent byproducts at one of a plurality of inlets 58. In this example, there are five cell stacks 22 and thus six open areas 56 potentially receiving vent byproducts. Each structural member 46 includes six inlets 58-one associated with each open area 56. The inlet 58 that receives the vent byproducts depends on which open area 56 is receiving vent byproducts. Vent byproducts that have moved through one of the inlets 58 move into one of a plurality of channels 62 within the structural member 46.

In this example, the structural members 46 each include a first channel 62A and a second channel 62B separated by a web 66. Vent byproducts received through the inlets 58A move into the channel 62A. Vent byproducts received through the inlets 58B move in to the channel 62B.

Vent byproducts that move through one of the inlets 58A into the channel 62A are communicated through the channel 62A in a first direction D1 to a first outlet 70A. The outlet 70A is an outlet from the channel 62A and the structural member 46. From the outlet 70A the vent byproducts move through a battery pack vent 74A to an area outside the battery pack 18.

Vent byproducts that move through one of the inlets 58B and move into the channel 62B are communicated in a second direction D2 to an outlet 70B from the structural member 46. Vent byproducts that pass through the outlet 70B move through a vent 74B from the traction battery pack 18. In the exemplary embodiment, the first direction is a direction toward a front of the electrified vehicle 10. The second direction is opposite the first direction and is a direction toward a rear of the electrified vehicle 10.

The structural members 46 each extend along a structural member axis. Along this axis, the inlets 58A are axially closer to the outlet 70B than to the outlet 70A, and the inlets 58B are axially closer to the outlet 70A than the outlet 70B. The inlets 58A are thus further from the outlet 70A than the outlet 70B, and the inlets 58B are further from the outlet 70B than the outlet 70A. Communicating vent byproducts received through one of the inlets 58A to the outlet 70A rather than the outlet 70B keeps the vent byproducts within one of the channels 62 of the structural member 46 longer than if the vent byproducts were communicated from the inlet 58A to the outlet 70B.

To ensure the vent byproducts within the channel 62A move through the outlet 70A, a plug 76A, in this example, is fit within the channel 62A at an opposite end of the structural member 46. Similarly, a plug 76B could fit within the channel 62B to direct flow out of the channel 62B through the outlet 70B.

Thermal energy within the flow of vent byproducts dissipates as the flow of vent byproducts move through one of the channels 62A and 62B of the structural member 46. Keeping the vent byproducts within the structural member 46 gives additional time for thermal energy to dissipate from the vent byproducts prior to being communicated outside the structural member 46 for discharging from the battery pack 18.

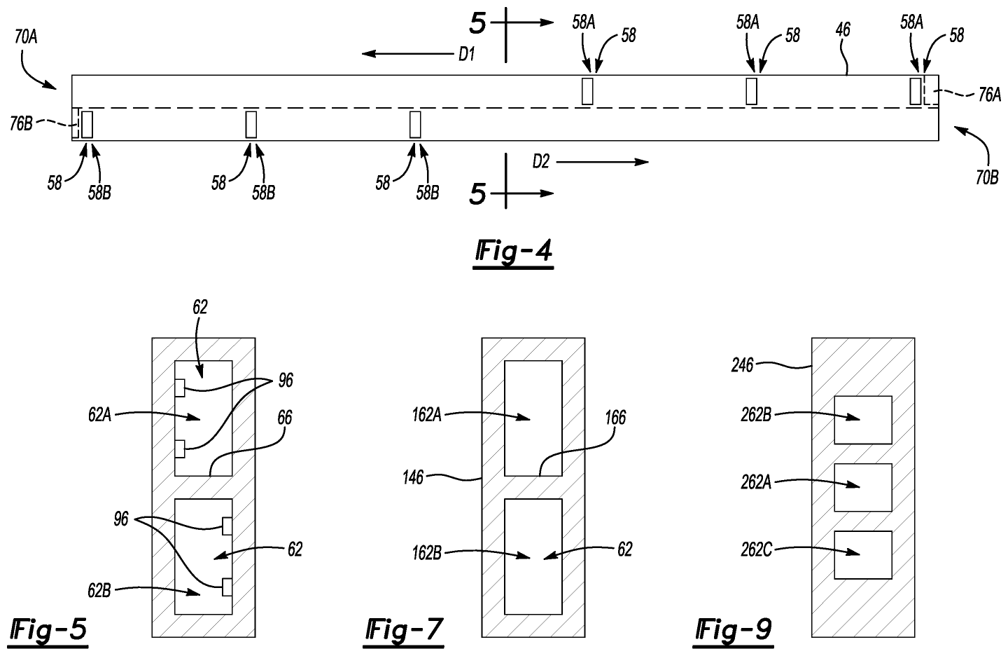

The structural member 46 on a passenger side is depicted in FIGS. 4 and 5. The structural member 46 on the driver side is constructed similarly.

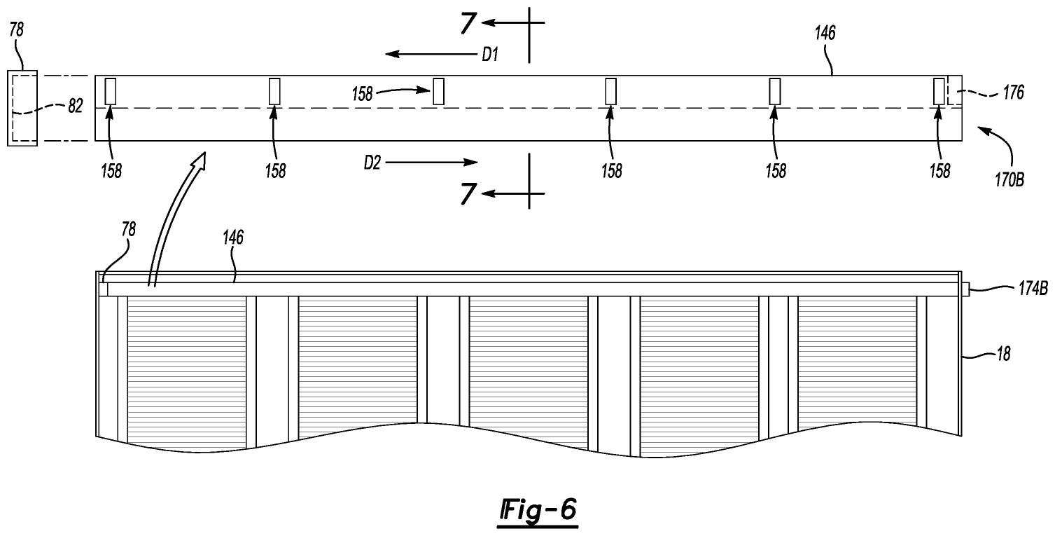

With reference now to FIGS. 6 and 7, in another exemplary embodiment, a structural member 146 includes a first channel 162A and a second channel 162B separated by a web 166. The structural member 146 includes a plurality of inlets 158 that all communicate a flow of vent byproducts into the channel 162A. From there, the vent byproducts flow through the channel 162A in the first direction D1, which is toward a front of the electrified vehicle 10 in this example.

The structural member 146 is associated with at least one endcap 78. The endcap 78 includes an endcap channel 82 that receives flow from the channel 162A of the structural member 146. The endcap channel 82 redirects the flow of vent byproducts received from the channel 162A into the channel 162B. As the endcap 78 is configured to redirect flow, the endcap 78 can be considered a flow redirecting member.

After being directed into the channel 162B, the vent byproducts communicate through the channel 162B in the second direction D2 toward a rear of the electrified vehicle 10. The flow of vent byproducts exits the channel 162B at an outlet 170B and then passes through a vent 174B from the traction battery pack 18. A plug 176 blocks vent byproducts from moving out of the structural member 146 without passing through the channel 162B.

Communicating the flow of vent byproducts in the first direction D1 through the first channel 162A and then in the second direction D2 through the second channel 162B can lengthen a time that the vent byproducts are contained within the structural member 146 when compared to communicating the vent byproducts through just the first channel 162A or the second channel 162B. This can facilitate thermal energy transfer from the vent byproducts to the structural member 146 prior to exhausting the vent byproducts from the traction battery pack 18 by lengthening a time the vent byproducts are within the structural member 146.

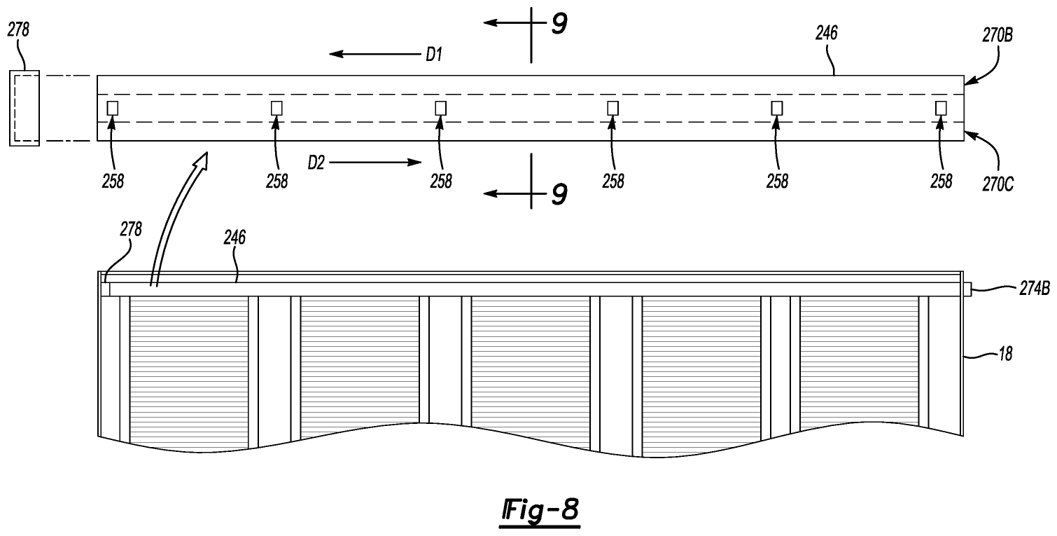

With reference to FIGS. 8 and 9, a structural member 246 that is usable with the battery pack 18 in another exemplary embodiment of the present disclosure includes three channels 262A, 262B, and 262C. The channel 262A is vertically sandwiched, or disposed, between the channel 262B and the channel 262C. The structural member 246 has, in this example, a significant cross-section of material at a vertical top of the structural member 246 and at a vertical bottom of the structural member 246. That is, most of the material of the structural member 246 is at the vertical top and vertical bottom of the structural member 246 as shown in the cross-sectional view of FIG. 9.

In the example structural member 246, the channel 262A receive flow of vent byproducts communicated through one of a plurality of inlets 258. The vent byproducts then flow through the first channel 262A in a first direction D1 toward a front of the vehicle 10.

An end cap 278 that is secured to an end portion of the structural member 246 is a redirecting member that redirects some of the vent byproducts received from the first channel 262A into the second channel 262B and some of the vent byproducts into the third channel 262C.

Since a cross-sectional area of the structural member 246 is increased at a vertical top and a vertical bottom of the structural member 246, redirecting the flow of vent byproducts into one of the channels 262B or 262C can facilitate thermal transfer to the structural member 246. This is due to, among other things, the increased material in these areas of the structural member 246 providing a sink for thermal energy.

Flow moves through the channel 262B or 262C in a second direction D2 toward a rear of the vehicle 10, and then exits the structural member 246 at an associated outlet 270B or 270C. From the outlet 270B or 270C, the flow of vent byproducts moves through the battery pack vent 274B to an area outside the battery pack 18.

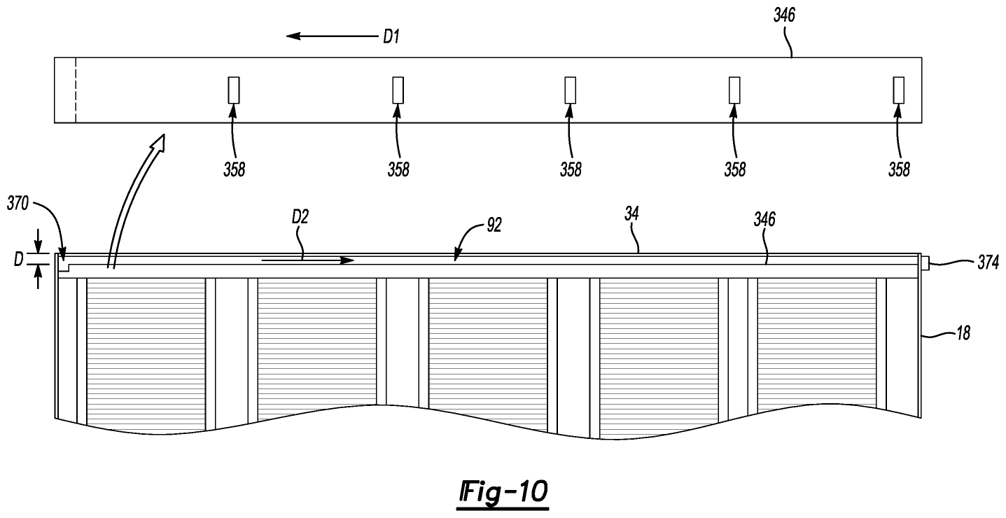

With reference now to FIG. 10, in a further exemplary embodiment, a structural member 346 usable within the battery pack 18 is spaced a distance D away from a sidewall 88 of the enclosure tray 34 to provide an area 92 between the structural member 346 and the sidewall of the enclosure tray 34.

The structural member 346 includes a plurality of inlets 358 to a channel 362. The flow of vent byproducts move into the channel 362 in the structural member 346 and initially move in the direction D1 until exiting the structural member 346 through an outlet 370.

The vent byproducts are then guided through the area 92 between the structural member 346 and the wall of the enclosure tray 34. The vent byproducts flow through this area 92 in the second direction D2 toward a rear of the vehicle 10. The vent byproducts then passes through a battery pack vent 374 to an area outside the traction battery pack 318.

Thermal energy in the flow of vent byproducts is reduced as the flow moves through the area 92. In some examples, the structural member 346 includes a plurality of ribs that increase a surface area of the structural member 346 where the vent byproducts moves over the structural member 346 when flowing through the area 92. Increasing the surface area of the structural member 346 in contact with the flow of vent byproducts can facilitate thermal transfer from the flow of vent byproducts.

Referring again to FIG. 5, in some examples, the channels 62 within the structural members 46 could be equipped with projections 96 that acting as turbulators to turbulate the flow of vent byproducts as the flow moves through the channels 62. Turbulating the flow can facilitate thermal transfer from the flow of vent byproducts to the structural member 46. Turbulators can be incorporated into any of the exemplary structural members of this disclosure.

Features of the disclosed examples include lengthening a time vent byproducts move through a battery pack prior to exhausting the vent byproducts from the battery pack.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack venting system, comprising:
a structural member having a first channel and a second channel, the first channel configured to communicate a flow of vent byproducts received through at least one first inlet in a first direction to a first outlet from the structural member, the second channel configured to communicate a flow of vent byproducts received through at least one second inlet in a second direction to second outlet from the structural member.

2. The battery pack venting system of claim 1, wherein the structural member extends along a structural member axis, wherein the at least one first inlet is axially closer to the second outlet than the first outlet, wherein the at least one second inlet is axially closer to the first outlet than the second outlet.

3. The battery pack venting system of claim 1, wherein the at least one first inlet and the at least one second inlet are each configured to receive a flow of vent byproducts from an area between a pair of cross-member assemblies.

4. The battery pack venting system of claim 1, wherein the structural member is an extruded structural member.

5. The battery pack venting system of claim 1, wherein the structural member spans a plurality of cell stacks.

6. A battery pack venting system, comprising:
a structural member having a first channel and a second channel, the first channel configured to communicate a flow of vent byproducts received through at least one inlet in a first direction, the second channel configured to communicate at least some of the flow of vent byproducts in an opposite, second direction.

7. The battery pack venting system of claim 6, wherein the structural member spans a plurality of cell stacks.

8. The battery pack venting system of claim 6, further comprising a redirecting member that receives the flow of vent byproducts from the first channel and redirects the flow of vent byproducts into the second channel.

9. The battery pack venting system of claim 6, wherein the second channel is configured to communicate at least some of the flow of vent byproducts an at least one outlet from the structural member.

10. The battery pack venting system of claim 6, further comprising a third channel of the structural member, the third channel configured to communicate at least some of the flow of vent byproducts that have passed through the first channel to at least one outlet from the third channel of the structural member, the flow of vent byproducts moving in the second direction through the third channel.

11. The battery pack venting system of claim 10, wherein the first channel is disposed between the second channel and the third channel.

12. The battery pack venting system of claim 10, further comprising a redirecting member that receives the flow of vent byproducts from the first channel and redirects some of the flow of vent byproducts into the second channel and some of the flow of vent byproducts into the third channel.

13. The battery pack venting system of claim 6, further comprising a third channel and fourth channel, the second channel configured to communicate at least some of the flow of vent byproducts from the first channel to the third channel and further configured to communicate at least some of the flow of vent byproducts from the first channel to the fourth channel.

14. The battery pack venting system of claim 13, wherein the first channel and the second channel are sandwiched between the third channel and the fourth channel.

15. A battery pack venting method, comprising:
communicating a flow of vent byproducts in a first direction through a channel of a structural member within a battery pack;
communicating the flow of vent byproducts in a second direction through an area between the structural member and an enclosure wall of the battery pack; and
communicating the flow of vent byproducts through a battery pack vent to an area outside the battery pack.

16. The battery pack venting method of claim 15, further communicating the vent byproducts to the structural member from an area between a pair of cross-member assemblies that each extend in a cross-vehicle direction, the structural member arranged transverse to pair of the cross-member assemblies.

17. The battery pack venting method of claim 15, further comprising turbulating the flow of vent byproducts using at least one turbulator of the structural member, of the enclosure wall, or both.

18. The battery pack venting method of claim 15, wherein the structural member spans a plurality of cell stacks.

19. The battery pack venting method of claim 15, wherein the communicating of the flow of vent byproducts in the second direction is outside of the structural member.
